(19) United States
(12) Patent Application Publication
(10) Pub. No.: US 2015/0056944 A1
(43) Pub. Date: Feb. 26, 2015

(54) METHOD AND SYSTEM FOR PROVIDING EMERGENCY NUMBER LIST TO USER IN CASE OF FAILED REGISTRATION

(71) Applicant: Samsung Electronics Co., Ltd., Gyeonggi-do (KR)

(72) Inventors: Shital Ranchhoddas Bhatiya, Bangalore (IN); Sourabh Jain, Nagda (IN)

(21) Appl. No.: 14/464,668

(22) Filed: Aug. 20, 2014

(30) Foreign Application Priority Data
Aug. 20, 2013 (IN) 3681/CHE/2013

(51) Int. Cl. H04M 1/725; H04W 4/22

(52) U.S. Cl. CPC H04M 1/72538; H04W 4/22
USPC 455/404.1; 455/566

(57) ABSTRACT

A method and system for providing local Emergency Number List (ENL) to a mobile device when mobile device fails to register with a network is disclosed. A mobile device obtains the ENL if it is determined that the mobile device has failed to register with the network. The mobile device obtains the ENL in a reject message. The mobile device can also obtain the local ENL when all the PLMNs in the mobile device are FPLMNs. The mobile device removes a PLMN from FPLMN list and performs a registration attempt with the removed PLMN and obtains the ENL in reject message. The mobile device obtains local ENL from network without a SIM/USIM. The mobile device sends a Connection Management (CM) service request along with CM service type as GET ENL to network. The mobile device obtains local ENL in CM service accept message from network.

### PRIORITY

The present application is related to and claims the benefit under 35 U.S.C. §119(a) of an Indian patent application filed on Aug. 20, 2013 in the Indian Patent Office and assigned Serial number 3681/CHE/2013, the entire disclosure of which is hereby incorporated by reference.

### TECHNICAL FIELD

The present disclosure relates to wireless communication systems and more particularly to protocol layer handling of emergency calls and emergency numbers in roaming scenarios and during failed registration attempts and in absence of Subscriber Identity Module (SIM).

### BACKGROUND

Mobile devices (for example, mobile phones or wireless telephones) have become a common part of everyday life. These devices have been extremely helpful in saving lives during emergencies. Mobile phones are frequently used to summon police, fire station, or ambulance to an emergency. The user of the mobile device, however, may need to know the emergency number of the particular country or area in order for the mobile device to place the emergency call during an emergency.

Sometimes mobile devices are pre-programmed to dial a specified emergency call number when an emergency call function or button is selected from a menu. However, when the mobile phone is roaming outside its home network, and in particular outside of its home country, the pre-programmed information may not include the correct emergency call number.

### SUMMARY

To address the above-discussed deficiencies, it is a primary object of the embodiments herein is to provide a method and system for providing local Emergency Number List (ENL) to a mobile device.

Another aspect of the present disclosure is to provide a method and system for providing local emergency number list from the network when a mobile device fails to register with the network or the mobile device has not attempted any registration with the network.

Yet another aspect of the present disclosure is to provide a method and system for providing local (ENL) when a SIM/USIM is absent in the mobile device.

Still another aspect of the present disclosure is to provide a method for providing a local Emergency Number List (ENL) to a mobile device. The method includes obtaining the local ENL from a network by the mobile device, when the mobile device fails to register with the network during one of a registration or an update attempt procedure. The method further includes displaying the local ENL obtained from the network along with a service category to a user of the mobile device.

A further aspect of the present disclosure is to provide a network for providing a local Emergency Number List (ENL) to a mobile device. The network is configured to send the ENL in a reject message to the mobile device, when the mobile device fails to register with the network during one of a registration or an update attempt procedure.

A further aspect of the present disclosure is to provide a mobile device for obtaining local Emergency Number List (ENL), wherein the mobile device comprises an integrated circuit. Further the integrated circuit includes at least one processor and at least one memory. The memory includes a computer program code within the integrated circuit. At least one memory and the computer program code with the at least one processor cause the mobile device to obtain the local ENL from a network, when registration with the network is failed during one of the registration or the update attempt procedure. Further, the mobile device is configured to display the local ENL obtained from the network along with a service category to a user.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an example mobile device with various modules according to this disclosure;

FIG. 2 illustrates an example of the various methods for obtaining an ENL from the network according to this disclosure;

FIG. 3 illustrates an example flow diagram explaining a process of obtaining an Emergency Number List (ENL) from the network in a REJECT message according to this disclosure;

FIG. 4 illustrates an example flow diagram explaining a process of obtaining an ENL from the network when only FPLMN are available according to this disclosure;

FIG. 5 illustrates an example flow diagram explaining a process of obtaining an ENL from the network in the absence of SIM/USIM in the mobile device according to this disclosure;

FIG. 6 is an example table illustrating a modified ROUTING AREA UPDATE REJECT message with the addition of ENL IE according to this disclosure;

FIG. 7 is an example table illustrating a modified GMM ATTACH REJECT message with the addition of ENL according to this disclosure;

FIG. 8 is an example table illustrating a modified LOCATION AREA UPDATING REJECT message with the addition of ENL according to this disclosure;

FIG. 9 is an example table illustrating a modified LTE ATTACH REJECT message with the addition of ENL according to this disclosure;

FIG. 10 is an example table illustrating a modified TRACKING AREA UPDATE REJECT message with the addition of ENL IE according to this disclosure;

FIG. 11 is an example table illustrating a modified CM service request message in order to request the network for sending local ENL according to this disclosure;

FIG. 12 is an example table illustrating a modified CM service TYPE IE with “GET ENL” as service type according to this disclosure;

FIG. 13 is an example table illustrating a modified CM SERVICE ACCEPT message with ENL IE addition according to this disclosure;

FIG. 14 illustrates an example sequence diagram in which a mobile device obtains a local ENL from the network when the SIM/USIM is absent according to this disclosure;

FIG. 15 illustrates an example flow diagram in which a User Interface (UI) is displayed in a mobile device to the user for selecting an emergency number according to this disclosure;

FIG. 16 illustrates an example flow diagram explaining a process for selecting an appropriate local emergency number on a display of a mobile device according to this disclosure; and

FIG. 17 illustrates an example computing environment implementing the method and system for obtaining a local ENL from a network according to this disclosure.

### DETAILED DESCRIPTION

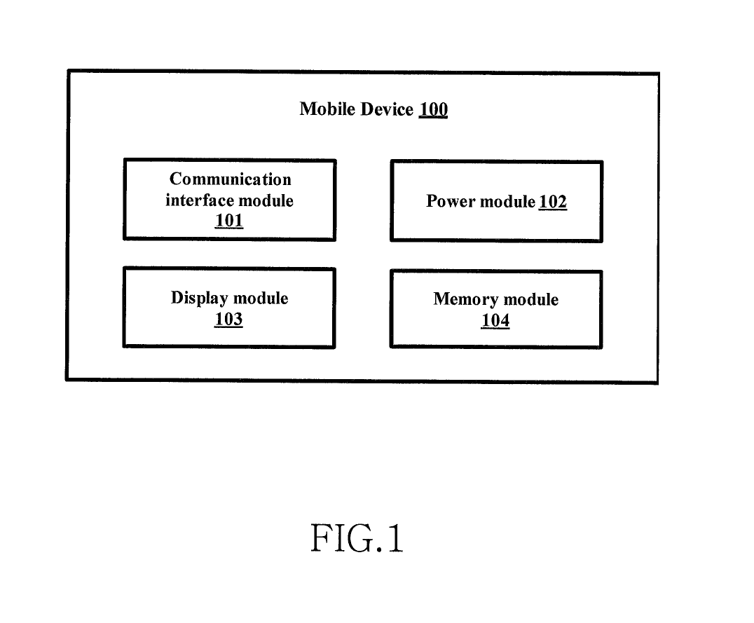

FIGS. 1 through 17, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile device. The embodiments disclosed herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

Mobile devices (for example, mobile phones or wireless telephones) have become a common part of everyday life. These devices have been extremely helpful in saving lives during emergencies. Mobile phones are frequently used to summon police, fire station, or ambulance to an emergency. The user of the mobile device, however, may need to know the emergency number of the particular country or area in order for the mobile device to place the emergency call during an emergency.

Emergency numbers for mobile phones are not globally unique and can vary from country to country. Countries can have different emergency numbers for each different emergency service type like ambulance, police, fire station, and so on. Such an Emergency Number List is typically stored in SIM/USIM and also configured in the mobile phones. Also 3GPP compliant mobile phone can have an optional provision to receive local Emergency Number List (ENL) on successful registration with the cellular network.

The user initiated emergency call number sequence is verified against the predetermined numbers stored in Subscriber Identity Module (SIM)/Universal Subscriber Identity Module (USIM), configured in the mobile phone and the local ENL downloaded by the serving network before deciding to setup the call as a normal call or as an emergency call for call establishment purpose.

Some existing systems have attempted to address the difficulty of providing the local ENL for the roaming users by means of storing the country specific ENL in the mobile phone and then selecting the list based on the Mobile Country Code (MCC) of the country where the user is present. However, the limitation in this case is that the ENL is preconfigured and may fail to provide the latest updated local emergency numbers to the users. Further, pre-configuring all the emergency numbers in the mobile phone can limit the number of such countries for which it can store the ENL. Further, the existing systems do not address the case when SIM is not present in the mobile phone when there is need to provide emergency number to its user.

Sometimes mobile devices are pre-programmed to dial a specified emergency call number when an emergency call function or button is selected from a menu. However, when the mobile phone is roaming outside its home network, and in particular outside of its home country, the pre-programmed information may not include the correct emergency call number.

The embodiments herein achieve a method and system for providing local Emergency Number List (ENL) to a mobile device when the mobile device fails to register with a network or the mobile device has not attempted to register with the network or when the mobile device camps for emergency services in absence of a SIM or an USIM. When a mobile device attempts to register to a network and if it is determined that the mobile device has failed to register with the network, then the network provides the local ENL to the mobile device.

In an embodiment, the network can provide the local ENL to the mobile device in a reject message.

The mobile device can also obtain the local ENL when all the Public Land Mobile Networks (PLMNs) in the mobile device are Forbidden Public Land Mobile Networks (FPLMNs). In this case, the mobile device can remove currently camped PLMN from the FPLMN list and send a registration or update attempt request with the removed PLMN. Hence, with this removed PLMN, the attach request sent by the mobile device will be failed. Further, the network provides a reject message when the mobile device has failed to register with the network.

In an embodiment, the network can provide the mobile device with the local ENL in the reject message.

Further, the mobile device can also obtain the local ENL from the network without a SIM/USIM. In this case, the mobile device can send a Connection Management (CM) service request to the network. The mobile device can obtain the local ENL in response to the CM service request in a CM service accept message from the network.

Once the mobile device obtains the local ENL from the network, the local ENL and associated service category is displayed to a user of the mobile device in a User Interface (UI). In order to initiate the emergency call, the user selects a number from the ENL that is displayed along with the service type and dials an emergency call to get the desired service.

Referring now to the drawings, and more particularly to FIGS. 1 through 17, where similar reference characters denote corresponding features consistently throughout the figures, there are shown preferred embodiments.

FIG. 1 illustrates a block diagram of an example mobile device with various modules according to this disclosure. As depicted in FIG. 1, the mobile device 100 includes a communication interface module 101, a power module 102, a display module 103 and a memory module 104. The communication interface module 101 helps the mobile device 100 to connect to the wireless network. The power module 102 holds the battery information and status of battery power in the mobile device 100. The battery information includes the amount of charge that the device possesses and the time period for which the mobile device 100 will be in operation and so on. The display module 103 of the mobile device 100 includes a user interface which can be a virtual keypad or through any other means by which a user can input some data into the mobile device 100. The display module 103, with respect to the embodiments described herein provides the display of each emergency number associated with the service category to the user.

The memory module 104 can include a random access memory (RAM) or another type of dynamic storage device that can store information and instructions, for example an application, for execution by processor, a read-only memory (ROM) device or another type of static storage device. In an embodiment, the memory module 104 can store the received ENL list from the network.

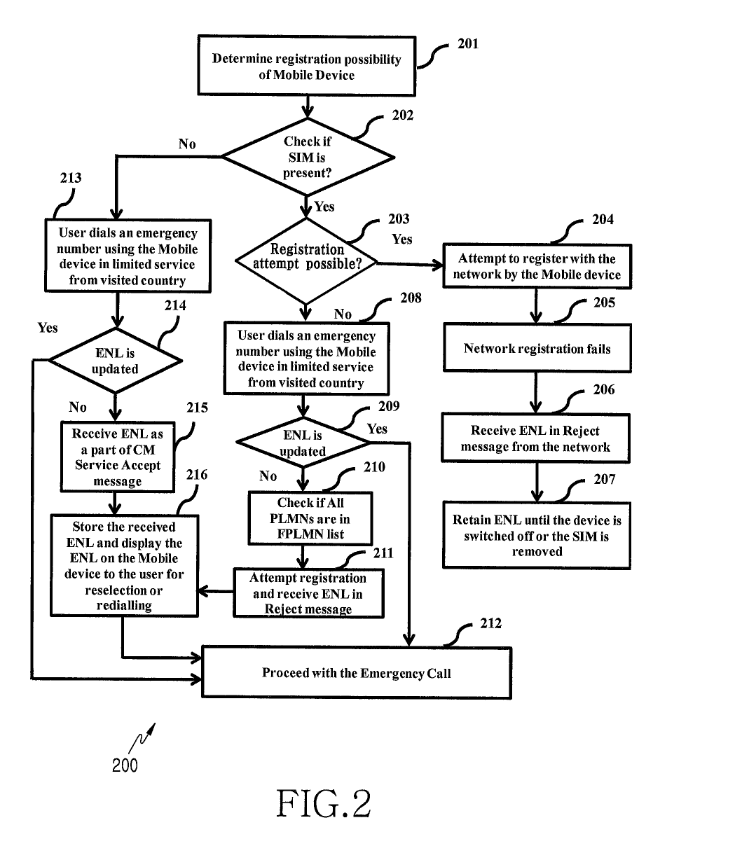

FIG. 2 illustrates an example of various methods for obtaining an ENL from the network according to this disclosure. Initially it is determined whether a registration with the network is possible for the mobile device 100 at step 201. If the registration is possible with the network by the mobile device 100, then, it is determined whether a SIM/USIM exists in the mobile device 100 as in step 202. If there exists a SIM/USIM in mobile device 100, then it is determined whether a registration attempt is possible with the network as in step 203. If the registration attempt is possible, then the mobile device 100 attempts to register with the network as in step 204.

Further, if the mobile device fails to register with the network as in step 205, then the mobile device 100 receives the ENL in the reject message along with the failure cause from the network as in step 206.

The mobile device 100 retains the received ENL from the network till the mobile device 100 is switched off or the SIM is removed from the mobile device 100 as in step 207.

In case, if it is determined that registration attempt is not possible for the mobile device 100 as in step 208, then the user can dial an emergency number using the mobile device 100 in limited service from the visited country. When the user dials an emergency number, it is determined whether the mobile device 100 has an updated ENL as in step 209. If the mobile device 100 has the updated ENL, then the mobile device proceeds with emergency call as in step 212.

If it is determined that the mobile device 100 has no updated ENL at step 209, then it is determined whether all the PLMN's are present in the FPLMN list of the mobile device 100 as in step 210. When all the PLMNs are present in FPLMN list, then the mobile device 100 at step 211 initiates a registration attempt on the camped PLMN. In this case, the mobile device 100 fails to register with the network (Since, the PLMN is a forbidden PLMN),

When the mobile device 100 fails to register with the network, then the mobile device at step 211 receives a local ENL as a part of reject message from the network.

The mobile device 100 at step 216 stores the received ENL and displays the ENL on the mobile device 100 to the user, where the user can reselect an emergency number or can redial the emergency number from the displayed ENL.

Furthermore, if there is no SIM/USIM in the mobile device 100 as in step 202 and if the user dials an emergency number using the mobile device 100 in limited service from the visited country as in step 213, then it is determined whether the mobile device 100 has an updated ENL as in step 214. If there is an updated ENL, then the mobile device 100 proceeds with the emergency call as in step 212.

If the mobile device 100 has no updated ENL as in step 214, then the mobile device 100 receives the ENL as a part of CM service accept message from the network as in step 215. When the mobile device receives the ENL from the network, then the mobile device 100 stores the received ENL and displays the ENL on the mobile device 100 to the user, where the user can reselect an emergency number or can redial the emergency number from the displayed ENL as in step 216. The various actions in flow diagram 200 can be performed in the order presented, in a different order or simultaneously. Further, in some embodiments, some actions listed in FIG, 2 can be omitted.

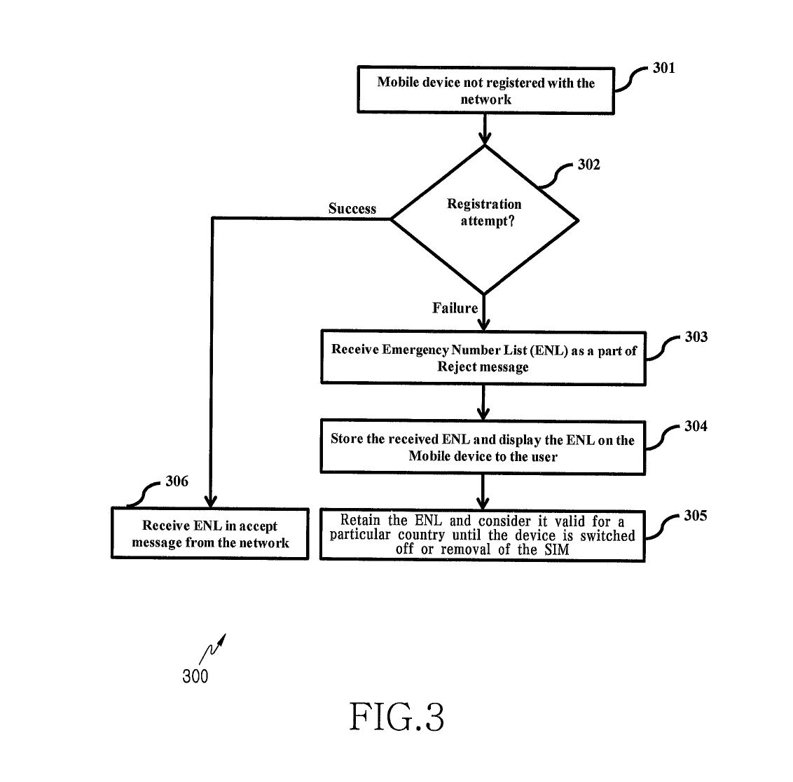

FIG. 3 illustrates an example flow diagram explaining a process of obtaining an Emergency Number List (ENL) from the network in a REJECT message according to this disclosure. The flow diagram 300 explains the method for obtaining the local ENL from the network when the mobile device 100 fails to register with the network. Initially, the mobile device 100 is not registered with the network as in step 301. In an embodiment, the mobile device can attempt registration with the network as in step 302, when, for example, the mobile device 100 is in the same country as its home country or any visited country.

If the registration attempt is succeeded then the mobile device 100 receives the ENL in accept message from the network as in step 306.

Further, the registration or update attempt request sent by the mobile device for registering with the network may not be accepted by the network in some situations.

In at least this scenario, the registration or update attempt request sent by the mobile device to the network will fail and the network sends a reject message, in response to the registration or update message sent by the mobile device 100.

In an embodiment, the mobile device 100 at step 303 can receive the ENL in the reject message along with the failure cause from the network.

In an embodiment, the reject message from the network can include local ENL Information Element (IE). The IE can be made optional in the reject message for maintaining backward compatibility.

At step 304 the mobile device 100 stores the received ENL and displays the ENL on the mobile device 100 to the user in a User Interface (UI). In an embodiment, the mobile device 100 receives the ENL from the network and its association with emergency service category (with the help of small icons) to form a User Interface (UI) for displaying the ENL to the user.

Further, at step 305 the mobile device 100 retains the received ENL from the network till the mobile device 100 is switched off or the SIM is removed from the mobile device 100. The various actions in flow diagram 300 can be performed in the order presented, in a different order or simultaneously. Further, in some embodiments, some actions listed in FIG. 3 can be omitted.

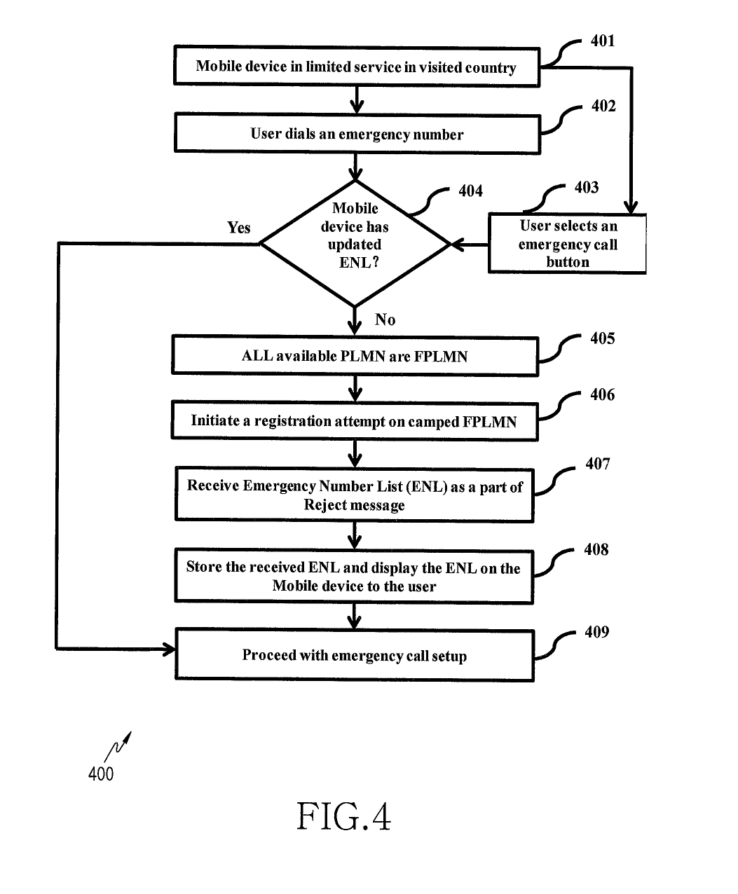

FIG. 4 illustrates an example flow diagram explaining a process of obtaining the ENL from the network when only FPLMN are available according to this disclosure. The flow diagram 400 describes the method for receiving the local ENL when only FPLM are available in the mobile device 100. Initially the mobile device 100 is in a limited service mode in the visited country at step 401. If the user dials an emergency number as in step 402 or if the user selects the emergency call button as in step 403, the mobile device 100 at step 404 checks whether it has an updated ENL. If there exists an updated ENL with the mobile device 100, then the mobile device 100 proceeds with the emergency call set ups as in step 409. If there is no updated ENL with the mobile device 100, then at step 405 the mobile device 100 determines whether all the available PLMNs are present in the FPLM list. If it is determined that all the available PLMNs present in the mobile device 100 are in the FPLMN list, then the mobile device 100 at step 406 initiates a registration attempt on the camped PLMN. In at least this case, the mobile device 100 fails to register with the network (Since, the PLMN is a forbidden PLMN).

When the mobile device 100 fails to register with the network, then the mobile device at step 407 receives a local ENL as a part of reject message from the network as step 407.

The mobile device 100 at step 408 stores the received ENL and displays the ENL on the mobile device 100 in the User Interface (UI). In an embodiment, the mobile device 100 receives the ENL from the network and its association with emergency service category (with the help of small icons) to form a User Interface (UI) for displaying the ENL to the user.

The mobile device 100 proceeds with the emergency call setup at step 409 if the user selects and dials an emergency number from the display of the mobile device.

Further, the mobile device 100 retains the received ENL from the network till the mobile device 100 is switched off or the SIM is removed from the mobile device 100. The various actions in flow diagram 400 can be performed in the order presented, in a different order or simultaneously. Further, in some embodiments, some actions listed in FIG. 4 can be omitted.

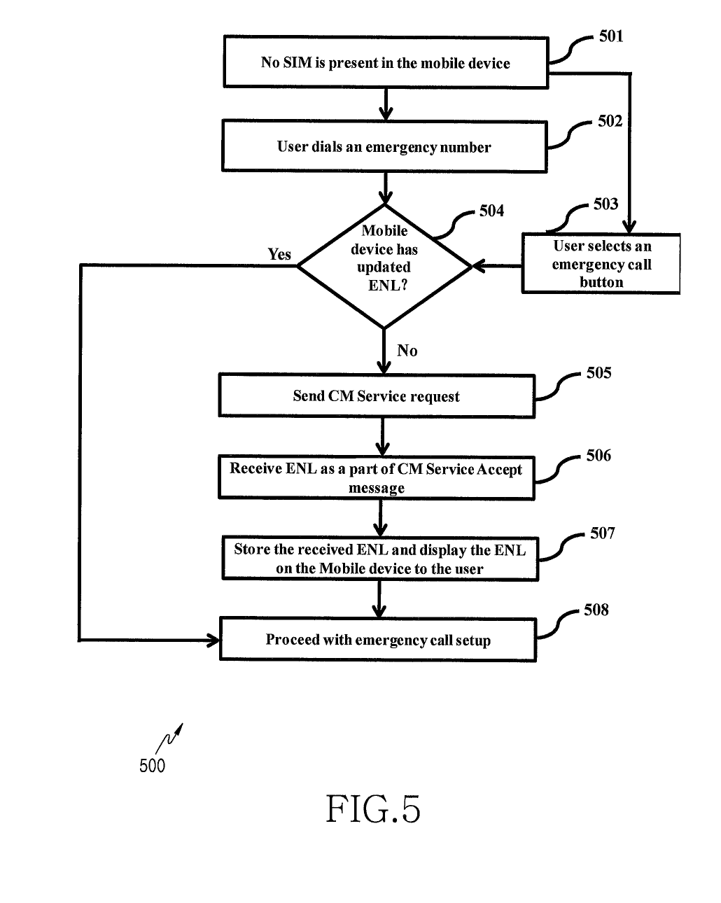

FIG. 5 illustrates an example flow diagram explaining a process of obtaining an ENL from the network in the absence of SIM/USIM in the mobile device according to this disclosure. The flow diagram 500 describes the method for obtaining the local ENL from the network when SIM/USIM is absent in the mobile device 100. In at least this scenario, the mobile device has no SIM/USIM as in step 501. The user dials an emergency call at step 502 or the user selects an emergency call button as in step 503. The mobile device determines whether it has an updated ENL at step 504. If the mobile device has an updated ENL, then the mobile device proceeds with emergency call setup as in step 508. If the mobile device is not having an updated ENL, then the mobile device 100 at step 505 sends a Connection Management (CM) service request message to the camped PLMN with new CM Service type as ‘Get ENL’ which can be used from reserved binary values: 3/5/6/7/12-15 and CKSN as ‘111’ since no valid CKSN available when no SIM is present.

The mobile device 100 at step 506 receives the local ENL in a CM service accept message from the network, in response to the CM service request message.

The mobile device 100 at step 507 stores the received ENL and displays the ENL on the mobile device 100 to the user in the User Interface (UI). In an embodiment, the mobile device 100 receives the ENL from the network and its association with emergency service category (with the help of small icons) to create the UI for displaying the ENL to the user.

The mobile device at step 508 proceeds with the emergency call setup once the user selects and dials the emergency number from the display of the mobile device 100. The various actions in flow diagram 500 can be performed in the order presented, in a different order or simultaneously. Further, in some embodiments, some actions listed in FIG. 5 can be omitted.

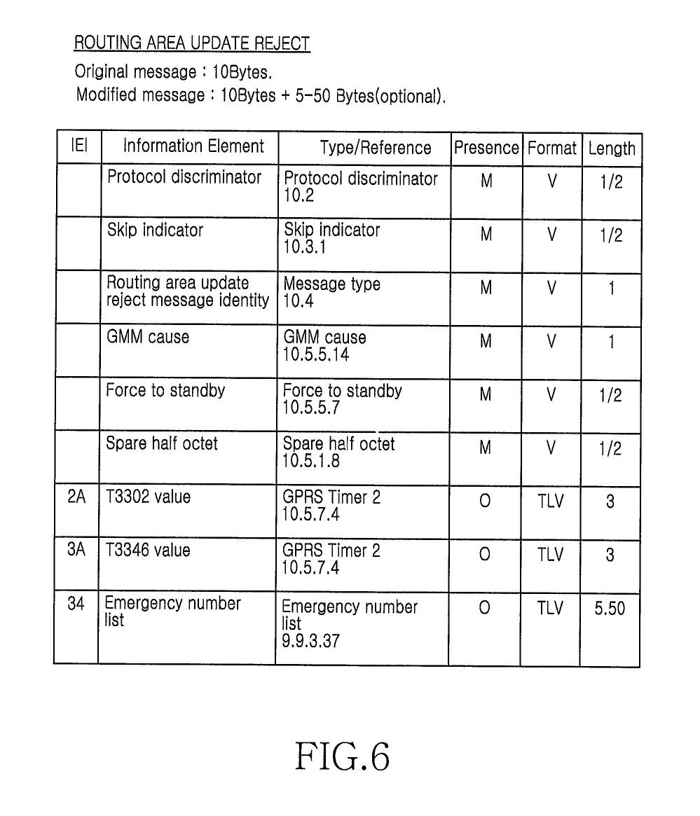

FIG. 6 is an example table illustrating a modified ROUTING AREA UPDATE REJECT message with the addition of ENL IE according to this disclosure. The ENL is provided to the mobile device 100 with the type, length, and value indicating the presence of the ENL.

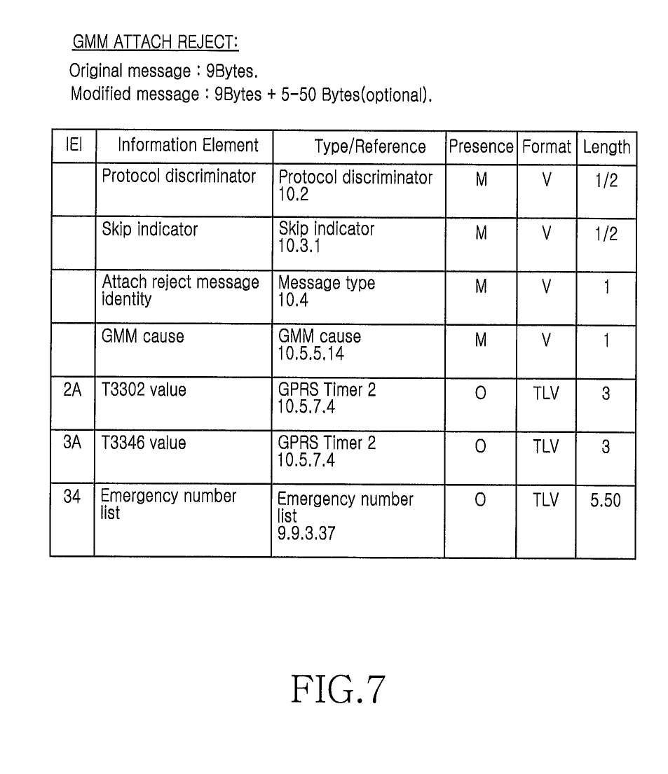

FIG. 7 is an example table illustrating a modified GMM ATTACH REJECT message with the addition of ENL according to this disclosure. The ENL is provided to the mobile device 100 with the type, length, and value indicating the presence of the ENL.

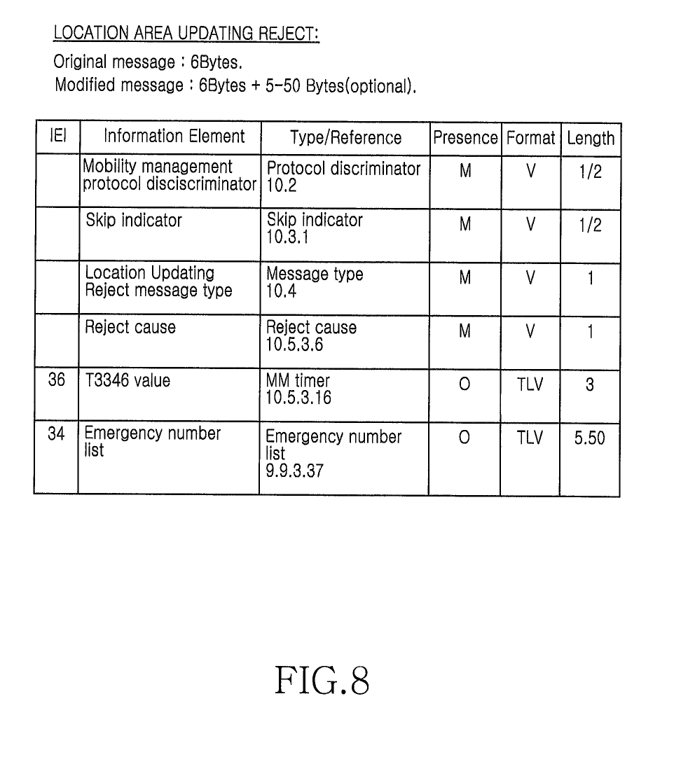

FIG. 8 is an example table illustrating a modified LOCATION AREA UPDATING REJECT message with the addition of ENL according to this disclosure. The ENL is provided to the mobile device 100 with the type, length, and value indicating the presence of the ENL.

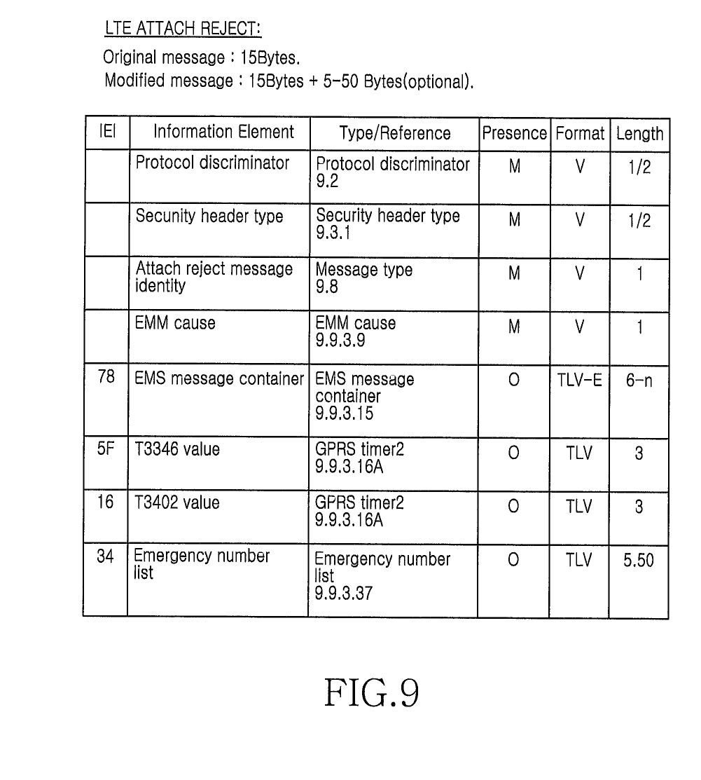

FIG. 9 is an example table illustrating a modified LTE ATTACH REJECT message with the addition of ENL according to this disclosure. If the mobile device 100 tries to access an Long Term Evolution (LTE) network, then during the REJECT message the LTE network provides the ENL to the mobile device 100. The ENL is provided to the mobile device 100 with the type, length, and value indicating the presence of the ENL.

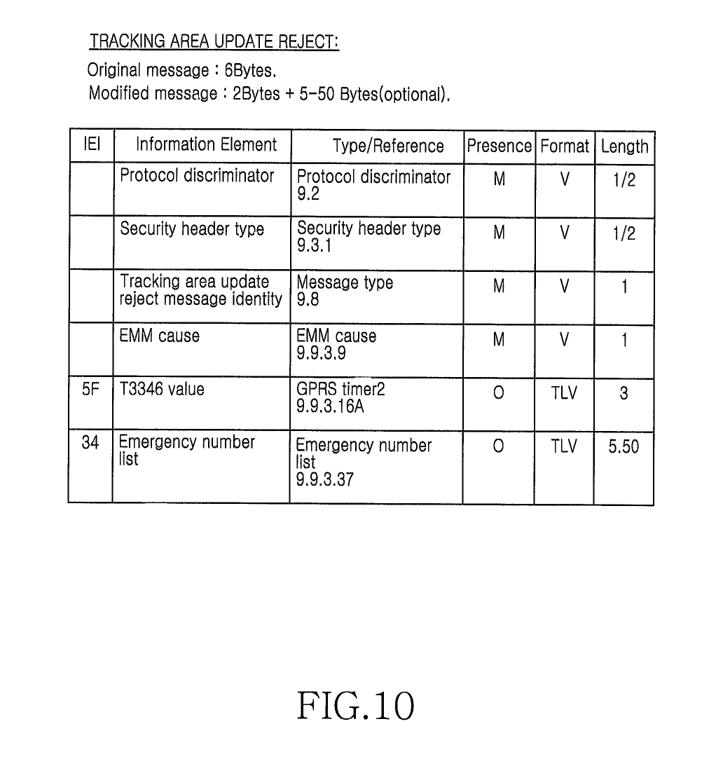

FIG. 10 is an example table illustrating a modified TRACKING AREA UPDATE REJECT message with the addition of ENL IE according to this disclosure. The ENL is provided to the mobile device 100 with the type, length, and value indicating the presence of the ENL.

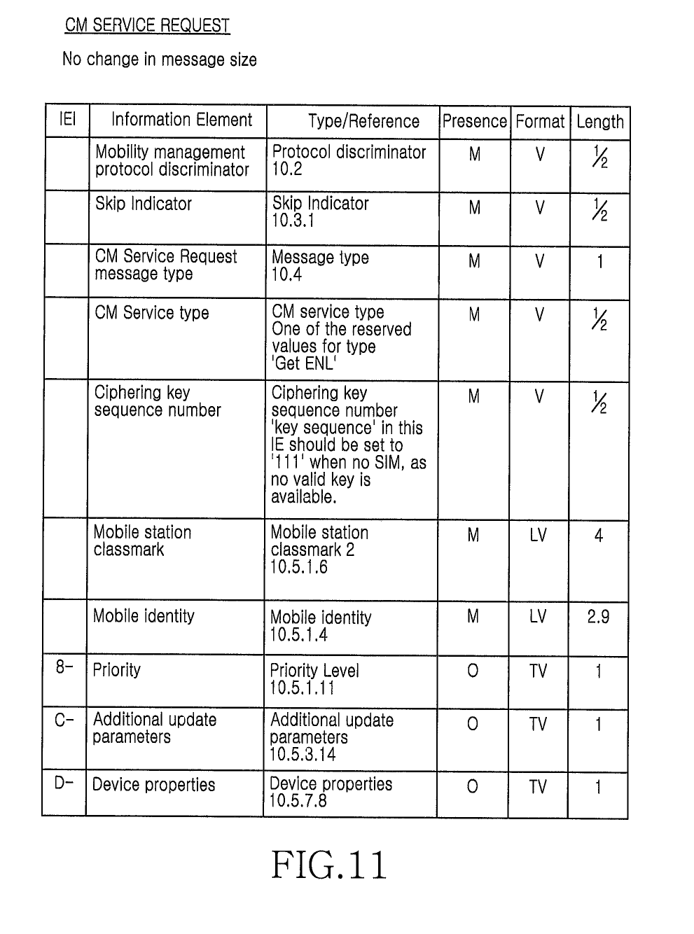

FIG. 11 is an example table illustrating a modified CM service request message in order to request the network for sending local ENL according to this disclosure. The proposed Information Element (IE) is highlighted in bold.

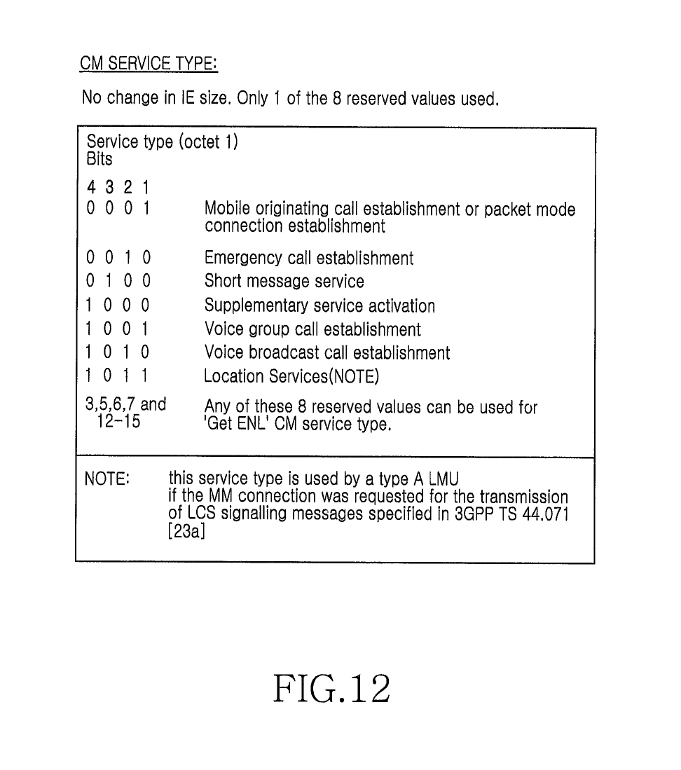

FIG. 12 is an example table illustrating a modified CM service TYPE IE with “GET ENL” as service type according to this disclosure. The proposed change in the reserved values is highlighted in bold.

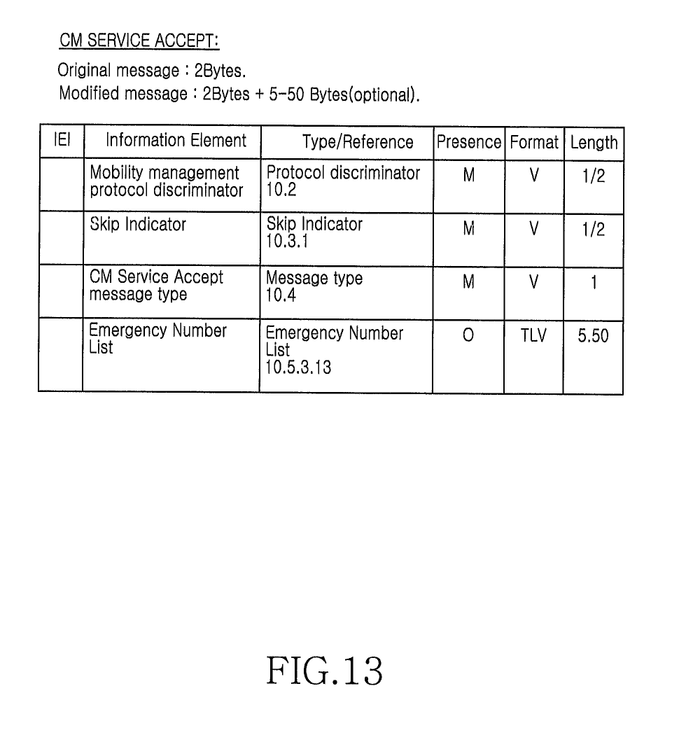

FIG. 13 is an example table illustrating a modified CM SERVICE ACCEPT message with ENL IE addition according to this disclosure. The ENL is provided to the mobile device 100 with the type, length, and value indicating the presence of the ENL.

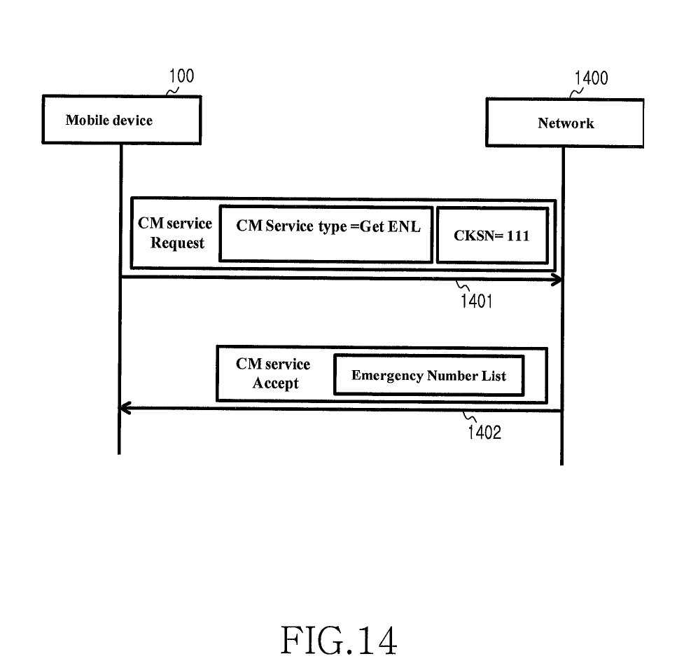

FIG. 14 illustrates an example sequence diagram in which a mobile device obtains the local ENL from the network 1400 when a SIM/USIM is absent according to this disclosure. When the SIM/USIM is absent in the mobile device 100, the mobile device 100 camps to any of the available PLMN within its coverage area. When the mobile device is camped on the available PLMN, the mobile device 100 sends (1401) the CM SERVICE REQUEST message to the network for obtaining the local ENL as shown in the sequence diagram.

In an embodiment, the mobile device 100 can send the CM service request message with new service type as ‘GET ENL’.

In an embodiment, the mobile device 100 can send the CM service request message with Cipher key sequence number (CKSN) as ‘111’ since no valid CKSN available when no SIM/USIM is present.

When the mobile device 100 sends the CM service request message to the network, the mobile device 100 obtains the local ENL in the CM service accept message from the network.

In embodiment, the mobile device 100 can obtain (1402) the CM service accept message along with the local ENL from the network, in response to the CM service accept message.

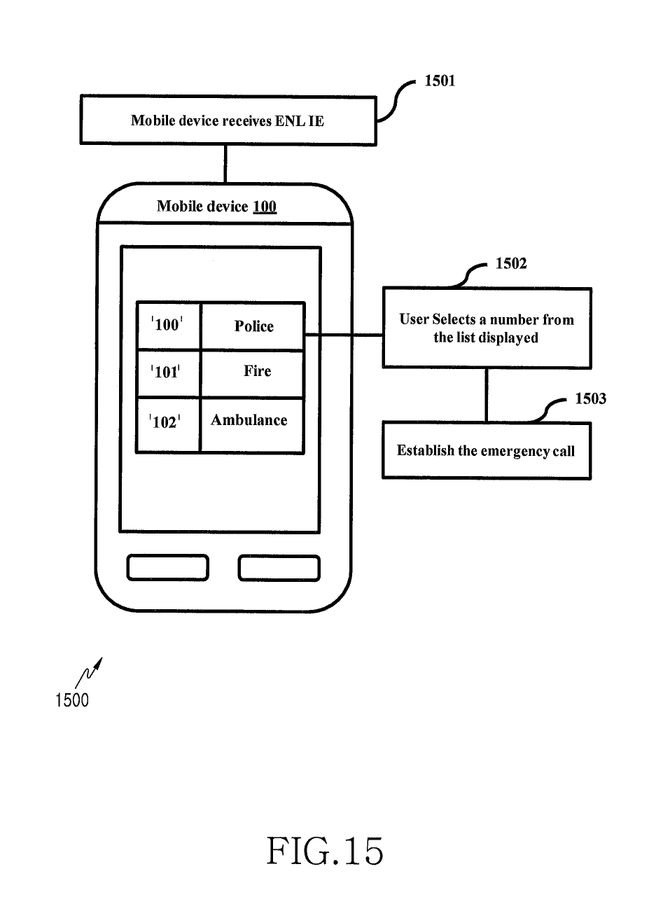

FIG. 15 illustrates an example flow diagram in which a User Interface (UI) is displayed in a mobile device to the user for selecting an emergency number according to this disclosure. As depicted in the FIG. 15, the mobile device receives (1501) the ENL from the network using the above described methods. After receiving the local ENL, the mobile device 100 provides the user with the available emergency services and emergency numbers with the help of the UI so that user can correctly select the emergency service number specific to the country where he/she is visiting.

When the mobile device 100 receives the local ENL, the mobile device 100 processes the received ENL, where each emergency number is associated with a service type or service category to form a list of emergency numbers along with the icons of desired service type.

The emergency list thus obtained after the processing will be displayed to the user in the UI as shown in the figure.

When the mobile device is in limited mode, the mobile device 100 displays emergency call icon and the local ENL along with the service type icon.

In order to initiate the emergency call, the user can select (1502) a number from the displayed list by means of touch or any other implementation dependent method based on the features supported by the mobile device 100.

When the user selects a particular emergency number from the displayed ENL, the mobile device 100 establishes (1503) the emergency call set up. The various actions in flow diagram 1500 can be performed in the order presented, in a different order or simultaneously. Further, in some embodiments, some actions listed in FIG. 15 can be omitted.

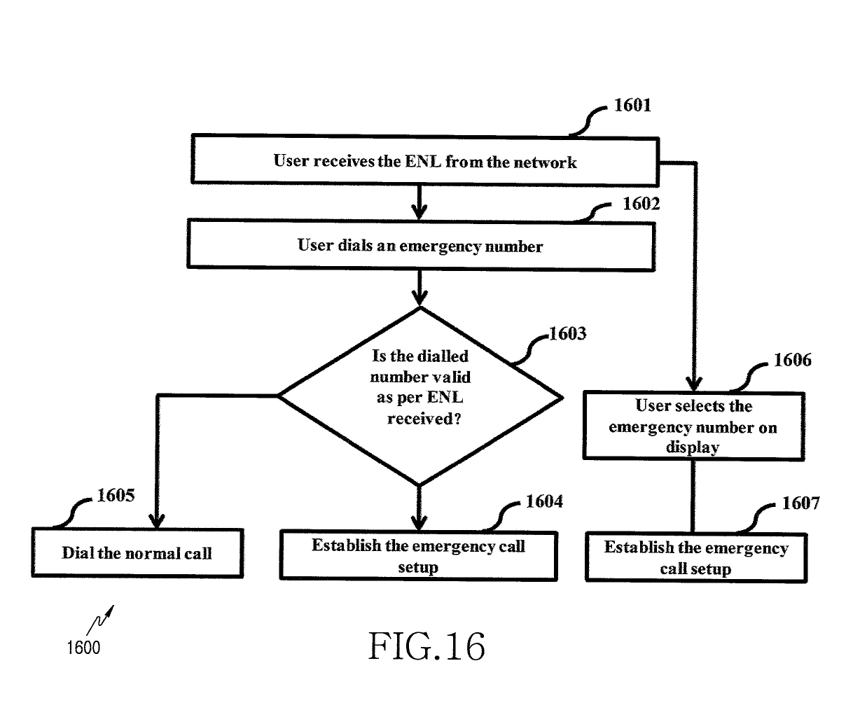

FIG. 16 illustrates an example flow diagram explaining a process for selecting an appropriate local emergency number on a display of a mobile device according to this disclosure. The flow diagram 1600 explains the method of selecting the appropriate local emergency number from the ENL displayed to the user for setting up an emergency call. The mobile device 100 receives (1601) the ENL from the network and stores the ENL. The user dials (1602) an emergency call from the ENL. It is determined (1603) whether the dialed number is valid by verifying the dialed number against the ENL received from the network. If the dialed number is valid, then the emergency call set up is established (1604) for providing the desired service to the user.

If the dialed number is not valid as per the ENL received from the network, then a normal call is established (1605)

In an embodiment, the mobile device 100 receives the ENL from the network and its association with emergency service category. The ENL and its associated service category are displayed to the user in UI (with the help of small icons). When the ENL is displayed to the user in a UI, the user can select (1606) an emergency number from the displayed ENL. When the user selects an emergency number, the emergency call is established (1607). The various actions in flow diagram 1600 can be performed in the order presented, in a different order or simultaneously. Further, in some embodiments, some actions listed in FIG. 16 can be omitted.

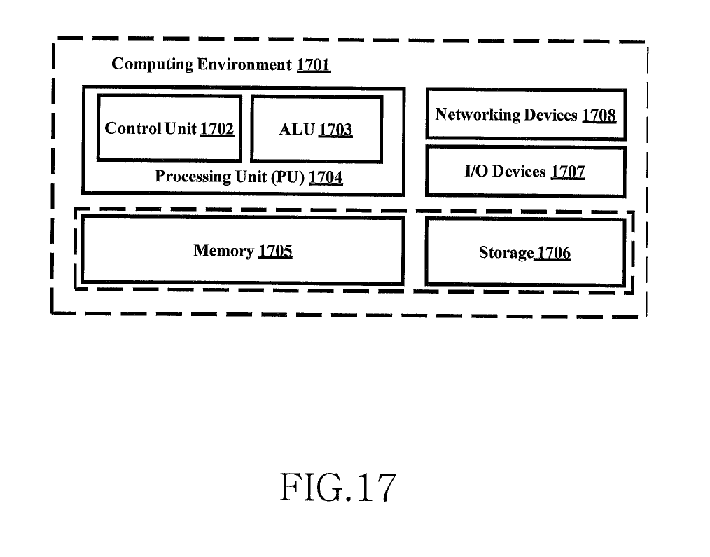

FIG. 17 illustrates an example computing environment implementing a method and system for obtaining the local ENL from a network according to this disclosure. As depicted the computing environment 1701 includes at least one processing unit 1704 that is equipped with a control unit 1702 and an Arithmetic Logic Unit (ALU) 1703, a memory 1705, a storage unit 1706, plurality of networking devices 1708 and a plurality Input output (I/O) devices 1707. The processing unit 1704 is responsible for processing the instructions of the algorithm. The processing unit 1704 receives commands from the control unit in order to perform its processing. Further, any logical and arithmetic operations involved in the execution of the instructions are computed with the help of the ALU 1703.

The overall computing environment 1701 can be composed of multiple homogeneous and/or heterogeneous cores, multiple CPUs of different kinds, special media and other accelerators. The processing unit 1704 is responsible for processing the instructions of the algorithm. Further, the plurality of processing units 1704 can be located on a single chip or over multiple chips.

The algorithm comprising of instructions and codes required for the implementation are stored in either the memory unit 1705 or the storage 1706 or both. At the time of execution, the instructions can be fetched from the corresponding memory 1705 and/or storage 1706, and executed by the processing unit 1704.

In case of any hardware implementations various networking devices 1708 or external I/O devices 1707 can be connected to the computing environment to support the implementation through the networking unit and the I/O device unit.

The embodiments disclosed herein can be implemented through at least one software program running on at least one hardware device and performing network management functions to control the elements. The elements shown in FIGS. 1 and 17 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for providing a local Emergency Number List (ENL) to a mobile device, the method comprising:
obtaining the local ENL from a network by the mobile device when the mobile device fails to register with the network during one of a registration and an update attempt procedure; and
displaying the local ENL obtained from the network along with a service category to a user on the mobile device.

2. The method as in claim 1, wherein the method further comprises obtaining the local ENL from the network in a reject message, wherein the reject message is received by the mobile device when the mobile device fails to register with the network during one of: the registration, and the update attempt procedure.

3. The method as in claim 1, wherein the method further comprises removing a Public Land Mobile Network (PLMN) that is present in a Forbidden PLMN (FPLMN) list by the mobile device and initiating a registration with the network, and obtaining the local ENL by the mobile device when the registration with the network is failed.

4. The method as in claim 3, wherein the method comprises obtaining the local ENL in the reject message from the network when the mobile device fails to register with the network during one of the registration and the update attempt procedure.

5. The method as in claim 1, wherein the method further comprises sending a Connection Management (CM) service request along with CM service type as GET ENL to the network by the mobile device for obtaining the local ENL from the network when one of a Subscriber Identity Module (SIM) and a Universal Subscriber Identity Module (USIM) is absent in the mobile device.

6. The method as in claim 5, wherein the method comprises obtaining the local ENL from the network in response to the CM service request by the mobile device, wherein the mobile device obtains the local ENL in a CM service accept message from the network.

7. The method as in claim 1, wherein the method comprises displaying the local ENL along with an associated service category to the user, wherein the local ENL is displayed to the user in a User Interface (UI).

8. A system for providing a local Emergency Number List (ENL) to a mobile device, wherein the system comprises:
at least one network; and
at least one mobile device configured to:
obtain the local ENL from the network when the mobile device fails to register with the network during one of a registration and an update attempt procedure, and
display the local ENL obtained from the network along with a service category to a user.

9. A network for providing a local Emergency Number List (ENL) to a mobile device, wherein the network is configured to:
send the ENL in a reject message to the mobile device when the mobile device fails to register with the network during one of a registration and an update attempt procedure.

10. The network as in claim 9, wherein the network is further configured to receive a Connection Management (CM) service request from the mobile device for providing the local ENL when one of a Subscriber Identity Module (SIM) and a Universal Subscriber Identity Module (USIM) is absent in the mobile device, wherein the ENL is provided to the mobile device in a CM service accept message.

11. The system as in claim 8, wherein the mobile device is configured to obtain the local ENL from the network in a reject message, wherein the reject message is received when the mobile device fails to register with the network during one of the registration and the update attempt procedure.

12. The system as in claim 8, wherein the mobile device is configured to remove a Public Land Mobile Network (PLMN) that is present in a Forbidden PLMN (FPLMN) list, initiate a registration with the network, and obtain the local ENL when the registration with the network is failed.

13. A mobile device for obtaining local Emergency Number List (ENL), wherein the mobile device comprises:
an integrated circuit including at least one processor;
at least one memory having a computer program code within the circuit;
the at least one memory and the computer program code with the at least one processor configured to cause the mobile device to:
obtain the local ENL from a network when registration with the network is failed during one of a registration and an update attempt procedure; and
display the local ENL obtained from the network along with a service category to a user of the mobile device.

14. The mobile device as in claim 13, wherein the mobile device is further configured to obtain the local ENL from the network in a reject message, wherein the reject message is received by the mobile device when the mobile device fails to register with the network during one of the registration, and the update attempt procedure.

15. The mobile device as in claim 13, wherein the mobile device is further configured to remove a Public Land Mobile Network (PLMN) that is present in a Forbidden PLMN (FPLMN) list, wherein the mobile device is configured to initiate a registration with the network, and wherein the mobile device is configured to obtain the local ENL when the registration with the network is failed.

16. The mobile device as in claim 15, wherein the mobile device is configured to obtaining the local ENL in the reject message from the network when the mobile device fails to register with the network during the attach procedure.

17. The mobile device as in claim 13, wherein the mobile device is configured to send a Connection Management (CM) service request to the network for obtaining the local ENL from the network when one of a Subscriber Identity Module (SIM) and a Universal Subscriber Identity Module (USIM) is absent in the mobile device.

18. The mobile device as in claim 17, wherein the mobile device is configured to obtain the local ENL from the network in response to the CM service request, wherein the mobile device is configured to obtain the local ENL in a CM service accept message from the network.

19. The mobile device as in claim 13, wherein the mobile device is configured to display the local ENL along with an associated service category to the user, wherein the local ENL is displayed to the user on a User Interface (UI).

20. The mobile device as in claim 13, wherein the mobile device is configured to assign a priority to the local ENL obtained from the network by ignoring emergency numbers stored in one of the SIM, the USIM, and preconfigured emergency numbers in the mobile device.
